(19) United States
(12) Patent Application Publication
(10) Pub. No.: US 2009/0218722 A1
(43) Pub. Date: Sep. 3, 2009

(54) CASTING DEVICE, AND SOLUTION CASTING METHOD AND APPARATUS

(75) Inventor: Akinori Ochiai, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/396,040

(22) Filed: Mar. 2, 2009

(30) Foreign Application Priority Data
Mar. 3, 2008 (JP) 2008-051981

(51) Int. Cl. B29C 39/14

(52) U.S. Cl. 264/214; 425/224

(57) ABSTRACT

A casting drum is rotated around a shaft. A peripheral surface of the casting drum moves in an X direction. A dope is discharged through a casting die onto the peripheral surface. A casting bead is formed so as to extend from a discharge port of the casting die to the peripheral surface. A decompression chamber decompresses an upstream side from the casting bead. Air flowing toward the casting bead is generated at the vicinity of the peripheral surface. A lateral labyrinth plate is disposed at a clearance between the decompression chamber and the peripheral surface. The lateral labyrinth plate is provided with a labyrinth groove extending along a width direction of the casting bead. An edge portion for forming the labyrinth groove has a cross section with an acute angle in a direction of air flowing between the decompression chamber and the support.

### FIELD OF THE INVENTION

The present invention relates to a casting device, and a solution casting method and apparatus.

### BACKGROUND OF THE INVENTION

A polymer film (hereinafter referred to as film) has advantages such as excellent light transmission properties and flexibility, and is easy to be made lighter and thinner. Accordingly, the film is widely used as an optical functional film. As a representative of the film, a cellulose ester film using cellulose acylate or the like has excellent toughness, and phase difference is small in the cellulose ester film. Therefore, the cellulose ester film is utilized as a base of photosensitive material. Additionally, the cellulose ester film is utilized as a protective film in a polarizing filter or an optical compensation film as a component of a liquid crystal display (LCD) whose market is increasingly expanded recently.

As a film production method, mainly, there are a melt-extrusion method and a solution casting method. In the melt-extrusion method, a polymer is heated to be melted, and then extruded by an extruder, to form a film. The melt-extrusion method has advantages such as high productivity and relatively low equipment cost. However, in the melt-extrusion method, it is difficult to adjust thickness of the film with high precision, and further fine streaks (die lines) easily occur on a surface of the film. Accordingly, it is difficult to produce a film having high quality as an optical functional film. On the contrary, in the solution casting method, a polymer solution (hereinafter referred to as a dope) containing a polymer and a solvent is cast onto a support to form a casting film. The casting film is hardened enough to be peeled and have a self-supporting property, and then peeled from the support to form a wet film. The wet film is dried to be a film. In the solution casting method, it is possible to obtain a film having more excellent optical isotropy and thickness evenness and containing less foreign substances in comparison with the melt-extrusion method. Therefore, the solution casting method is mainly adopted for a producing method of an optical functional film for use in the LCD.

In the solution casting method, the dope is prepared by dissolving a polymer such as cellulose triacetate into a mixed solvent containing dichloromethane or methyl acetate as a main solvent. Then, a defined additive is mixed with the dope to prepare a casting dope. The casting dope is cast through a casting die onto a support such as a casting drum and an endless belt to form a casting film (hereinafter referred to as a casting process) The casting film is hardened enough to be peeled and have a self-supporting property on the support. Thereafter, the casting film is peeled as a wet film from the support. The wet film is dried and wound as a film.

Recently, in accordance with rapid increase in demand for the LCD and the like, a solution casting method having high production efficiency has been desired. In view of increasing the production efficiency, the speed at which the casting process is performed is slowest in the solution casting method. Therefore, for the purpose of speeding up the solution casting method, the moving speed of the support is made faster, and an upstream side from a casting bead in the moving direction of the support is decompressed by using a decompression means such as a decompression chamber. Note that, the casting bead is the casting dope extending from the casting die to the support.

During the casting process, when the clearance between the support and the decompression chamber is changed, the following problems occur in some cases. In accordance with pressure fluctuation inside the decompression chamber, a position of the support where the dope reaches is changed, and thereby thickness unevenness of the casting film occurs. Air enters between the casting film and the surface of the support in accordance with decrease in adhesion degree between the surface of the support and the casting bead. Accordingly, thickness unevenness of the film and defects on the surface of the film (surface undulation generated in the longitudinal and width directions of the film) occur. In view of the above, a film production apparatus as follows is disclosed in Japanese Patent Laid-Open Publication No. 2001-79864. In the film production apparatus, the clearance between the support and the decompression chamber is detected. When the clearance is less than a preset level, the decompression chamber is caused to move, to set the clearance between the support and the decompression chamber to the preset level or more.

Additionally, in a polymer film production method disclosed in Japanese Patent Laid-Open Publication No. 2002-103358, a wind shielding plate or fin as a wind shielding member is disposed at the vicinity of the casting die. In a cellulose ester film production apparatus disclosed in Japanese Patent Laid-Open Publication No. 2003-1655, the decompression chamber is provided with an adjustment plate as a labyrinth seal movable in a vertical direction, and in accordance with the vertical movement of the adjustment plate, the clearance between the adjustment plate and the surface of the support is adjusted.

However, when the solution casting method is performed continuously for long hours, the decompression chamber and the labyrinth seal drop by their own weight. Due to the dropping of the decompression chamber and the labyrinth, the clearance between the support and the labyrinth seal is changed, and thereby the pressure inside the decompression chamber is also changed. Thus, the quality of the film is decreased. Additionally, the distance between an original position of the labyrinth seal and a position of the labyrinth seal after the dropping varies with time, and therefore it is difficult to adjust the position of the labyrinth seal in consideration of the dropping. Accordingly, the time required for adjustment becomes longer and production efficiency is decreased.

Therefore, in the method for adjusting the clearance between the support and the decompression chamber at a preset level to prevent the pressure fluctuation inside the decompression chamber during the casting process, the working efficiency is poor, and there is a limit for producing a film efficiently.

### SUMMARY OF THE INVENTION

In view of the above, an object of the present invention is to provide a casting device, and a solution casting method and apparatus capable of easily preventing pressure fluctuation inside a decompression chamber.

In order to achieve the above and other objects, a casting device of the present invention includes a support moving continuously, a casting die, and a decompression chamber. A casting die is used to discharge a casting dope onto the support to form a casting film. A decompression chamber is used to suck air of an upstream area from a casting bead in a moving direction of the support to decompress the upstream area. The casting bead is the casting dope extending from the casting die to the support. Two ledges are provided on the decompression chamber to form a labyrinth groove between the decompression chamber and the support. The labyrinth groove extends in a direction perpendicular to air flowing between the decompression chamber and the support. Each of the ledges includes an edge portion. The edge portion has a cross section with an acute angle in a direction of the flowing air. The flowing air occurs with the sucking. The labyrinth groove is formed between the edge portions.

Preferably, the edge portion is formed by a perpendicular surface perpendicular to the moving direction of the support and an inclined surface intersecting with the perpendicular surface such that the perpendicular surface and the inclined surface makes an acute angle. The labyrinth groove is preferably formed by the perpendicular surface and the inclined surface provided alternately in this order from an upstream side in the direction of the flowing air occurring with the suction. Preferably, the casting device further includes a shielding member disposed at both end portions in a longitudinal direction of the labyrinth groove. The shielding member is used for closing the labyrinth groove to shield the flowing air occurring with the suction. The support is preferably a drum rotated around a center of its cross section. The casting film is formed on a peripheral surface of the support.

A solution casting device of the present invention includes the casting device described above, and a drier for drying the casting film peeled from the support to form a film.

According to a solution casting method of the present invention, a casting dope is discharged from a casting die onto a support moving continuously to form a casting film. An upstream area from a casting bead in a moving direction of the support is sucked to decompress the upstream area by a decompression chamber. The casting bead is the casting dope extending from the casting die to the support. Air flowing between the decompression chamber and the support is compressed by one of two ledges for forming a labyrinth groove. The labyrinth groove extends in a direction perpendicular to the flowing air. The air occurs with the sucking. The compressed air is swollen by the labyrinth groove formed between edge portions. Each of the edge portions is provided at the ledges. The casting film is peeled from the support. The peeled casting film is dried to form a film.

According to the present invention, each of the pair of ledges for constituting the labyrinth groove includes an edge portion having a cross section with an acute angle. Therefore, the air flowing between the edge portion of the labyrinth groove and the support is compressed and further swollen in the labyrinth groove. As a result, it is possible to prevent the air from entering the decompression chamber. Accordingly, according to the present invention, it is possible to prevent pressure fluctuation inside the decompression chamber. Thus, it is possible to efficiently produce the film while preventing occurrence of thickness unevenness.

### DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory view schematically illustrating a film production line;

FIG. 2 is a side view schematically illustrating a casting die, a casting drum, and a decompression chamber;

FIG. 3 is an exploded perspective view schematically illustrating the decompression chamber;

FIG. 4 is a plan view schematically illustrating the decompression chamber viewed from a peripheral surface of the casting drum;

FIG. 5 is a cross sectional view taken along lines V-V of FIG. 4, schematically illustrating a lateral labyrinth plate and members at the vicinity of the lateral labyrinth plate according to a first embodiment;

FIG. 6 is a plan view of a portion surrounded by a chain double-dashed line VI of FIG. 4, schematically illustrating a labyrinth groove, viewed from the peripheral surface of the casting drum;

FIG. 7 is a cross sectional view schematically illustrating a lateral labyrinth plate according to a second embodiment;

FIG. 8 is a perspective view schematically illustrating a lateral labyrinth plate, a side labyrinth plate, and a shielding member according to a third embodiment;

FIG. 9 is a perspective view schematically illustrating a lateral labyrinth plate according to a fourth embodiment;

FIG. 10 is a cross sectional view schematically illustrating a lateral labyrinth plate according to a fifth embodiment;

FIG. 11 is a partial cross sectional view schematically illustrating a decompression chamber used in Examples;

FIG. 12 is a graph plotting a decompression degree P in the decompression chamber, an air flow velocity V sucked by a duct at the decompression degree P in Example 1;

FIG. 13 is a graph plotting a decompression degree P in the decompression chamber, an air flow velocity V sucked by a duct at the decompression degree P in Experiments 1 and 2 of Example 2; and

FIG. 14 is a graph plotting a decompression degree P in the decompression chamber, an air flow velocity V sucked by a duct at the decompression degree P in Experiment 3 of Example 2 and Experiment 3 of Example 1.

### DESCRIPTION OF THE PREFERRED EMBODIMENTS

Hereinafter, preferred embodiments of the present invention are described in detail. However, the present invention is not limited thereto.

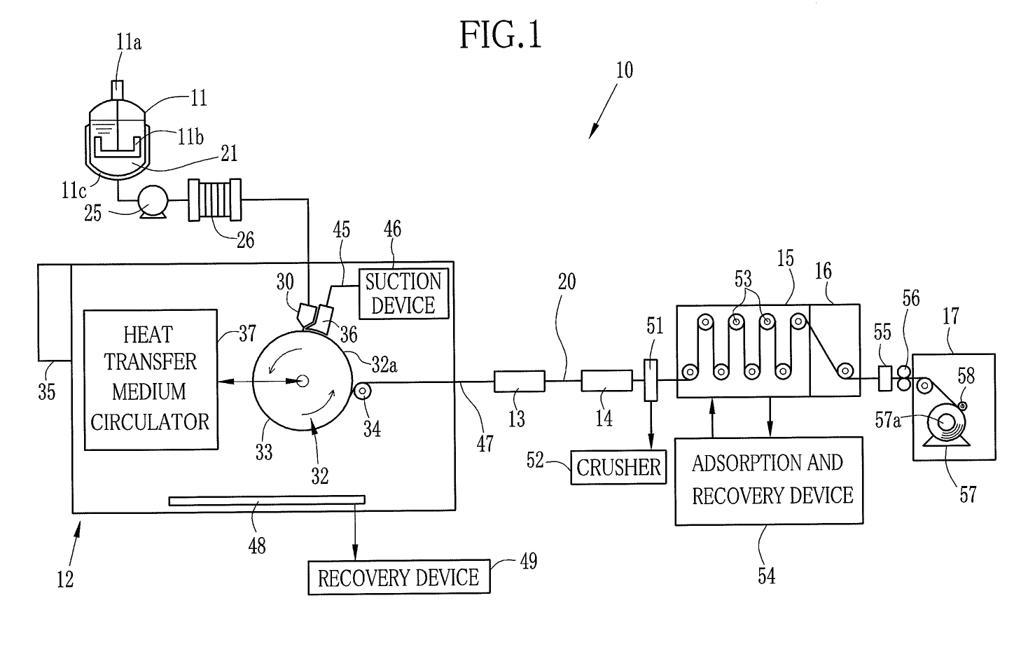

As shown in FIG. 1, a film production line 10 includes a stock tank 11, a casting chamber 12, a pin tenter 13, a clip tenter 14, a drying chamber 15, a cooling chamber 16, and a winding chamber 17.

The stock tank 11 is provided with a stirrer blade 11b rotated by a motor 11a and a jacket 11c. Inside the stock tank 11 is stored a dope 21 as a raw material for a film 20. A heat transfer medium flows inside the jacket 11c of the stock tank 11 such that a temperature of the dope 21 is adjusted to be within the range of 25° C. to 35° C. Since the stirrer blade 11b is rotated by the motor 11a in the stock tank 11, it is possible to keep the dope 21 in a constant state while preventing aggregation of a polymer and the like.

A pump 25 and a filtration device 26 are disposed in a downstream side from the stock tank 11. An adequate amount of the dope 21 is arbitrarily poured into the filtration device 26 from the stock tank 11 by use of the pump 25, and filtered by the filtration device 26. Thereby, impurities are removed from the dope 21.

The casting chamber 12 includes a casting die 30, a casting drum 32, a peeling roller 34, a temperature adjuster 35, and a decompression chamber 36 so as to constitute a casting device. The casting die 30 is used as a means for discharging the dope 21. The casting drum 32 is an endless support. The peeling roller 34 is used to peel a casting film 33 from the casting drum 32. The temperature adjuster 35 adjusts the temperature inside the casting chamber 12. The decompression chamber 36 is used as a decompression means.

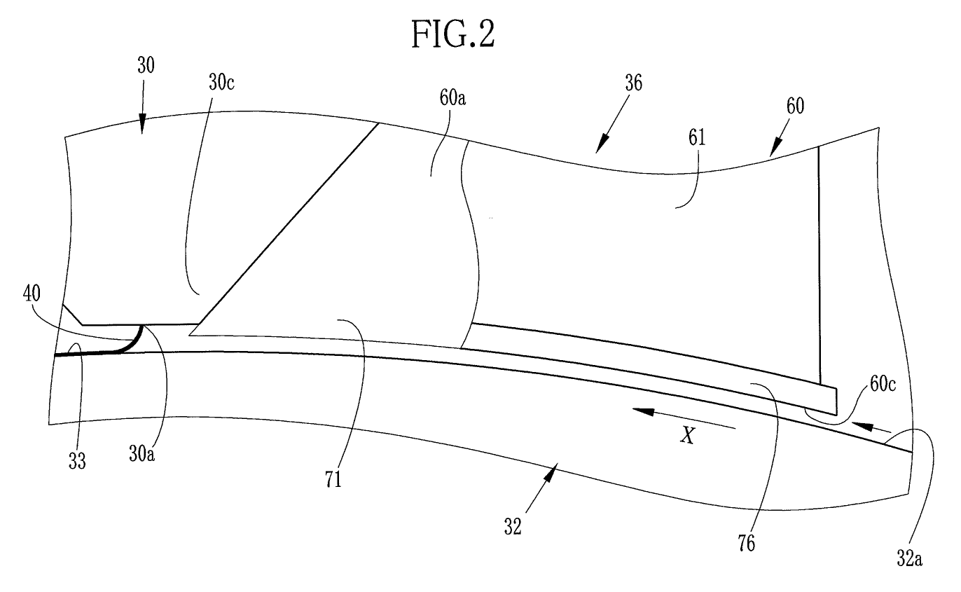

As shown in FIG. 2, a discharge port 30a for discharging the dope 21 is provided at a front end of the casting die 30. The dope 21 is cast through the discharge port 30a onto a peripheral surface 32a of the casting drum 32 disposed under the discharge port 30a. A material for the casting die 30 has high resistance to corrosion against an electrolyte aqueous solution, and a mixed liquid of methylene chloride, methanol, and the like. A coefficient of thermal expansion of the material for the casting die 30 is low. Accuracy of finishing of a contact surface of the casting die 30 to the liquid is preferably 1 μm or less in the surface roughness, and straightness thereof is preferably 1 μm/m or less in any direction. The casting die 30 as described above is used to form the casting film 33 having no streaks and thickness unevenness on the peripheral surface 32a of the casting drum 32.

As shown in FIGS. 1 and 2, the casting drum 32 has an approximately cylindrical shape, and is rotated around a center of its cross section as a shaft by a not-shown driver. The not-shown driver causes the casting drum 32 to rotate such that the peripheral surface 32a of the casting drum 32 moves in a predetermined moving direction (hereinafter referred to as X direction) at a predetermined moving speed within the range of 10 to 300 m/min. The peripheral surface 32a of the casting drum 32 is subjected to chrome plating so as to have sufficient resistance to corrosion and strength. A heat transfer medium circulator 37 is attached to the casting drum 32. The temperature of the heat transfer medium is kept at a desired value by the heat transfer medium circulator 37. The heat transfer medium flows inside a heat transfer medium passage in the casting drum 32 such that a surface temperature of the casting drum 32 is kept within a desired range.

During a casting process, the dope 21 is discharged through the discharge port 30a onto the peripheral surface 32a of the casting drum 32 so as to form a casting bead 40 extending from the discharge port 30a to the peripheral surface 32a. The dope 21 is cast onto the moving peripheral surface 32a and spread thereon so as to form the casting film 33. The casting film 33 is conveyed in the X direction at a predetermined speed in accordance with the rotation of the casting drum 32. As described above, the dope 21 is continuously cast onto the moving peripheral surface 32a of the casting drum 32 so as to form the long casting film 33 on the peripheral surface 32a.

The decompression chamber 36 is disposed in an upstream side from the casting die 30 in the X direction, and connected to a suction device 46 through a pipe 45. The decompression chamber 36 sucks air of a cavity 60a of the decompression chamber 36 by the suction device 46, and as a result, the upstream side from the casting bead 40 is decompressed such that the pressure in the upstream side from the casting bead 40 in the moving direction of the peripheral surface 32a is lower than that in the downstream side by 10 Pa to 1500 Pa. In accordance with the decompression, degree of adhesion between the peripheral surface 32a and the casting bead 40 is increased, and therefore it is possible to prevent air from entering between the casting film 33 and the peripheral surface 32a. The casting film 33 is cooled on the casting drum 32 so as to be hardened enough to have a self-supporting property. Thereafter, the casting film 33 is peeled from the casting drum 32 by use of the peeling roller 34 to be a wet film 47.

As shown in FIG. 1, the temperature inside the casting chamber 12 is adjusted to be approximately constant within a predetermined range by the temperature adjuster 35. The temperature inside the casting chamber 12 is preferably in the range of 10° C. to 30° C. Inside the casting chamber 12 is provided a condenser 48. Outside the casting chamber 12 is provided a recovery device 49. The solvent vapor in the casting chamber 12 is condensed into liquid by the condenser 48, and further recovered by the recovery device 49. The liquid is refined by a refining device to be reused as an organic solvent for preparing the dope. A condensation point of the solvent in the casting chamber 12 is kept within the range of −10° C. to 25° C. In a case where the condensation point of the solvent in the casting chamber 12 is less than −10° C., the solvent easily evaporates. Therefore, plate out easily occurs, unfavorably. Note that the plate out means precipitation of some undesired substances on the peripheral surface 32a. In contrast, in a case where the condensation point of the solvent in the casting chamber 12 exceeds 25° C., condensation of the solvent easily occurs on the peripheral surface 32a. The condensation of the solvent causes defect on the surface of the film, unfavorably. Note that, the condensation point means the temperature at which condensation of the solvent contained in the atmosphere starts.

The pin tenter 13 and the clip tenter 14 are disposed in the downstream side from the casting chamber 12. In the pin tenter 13, the wet film 47 is dried to be a film 20. In the clip tenter 14, the film 20 is stretched while being dried. In the pin tenter 13, plural pins are inserted into the side ends of the wet film 47 and fixed thereto. While being conveyed in the pin tenter 13, the wet film 47 is dried to be the film 20. The film 20 still containing the solvent is sent to the clip tenter 14.

In the clip tenter 14, side ends of the film 20 are held by the plural clips moving continuously in accordance with the moving chain. Thereafter, while being conveyed in the clip tenter 14, the film 20 is dried. The distance between the clips opposed to each other in the width direction of the film 20 is increased so as to apply tension to the width direction of the film 20. Thereby, the film 20 is stretched. As described above, since the film 20 is stretched in the width direction, molecules in the film 20 are orientated, and thereby the film 20 comes to have optical properties such as retardation. Note that the clip tenter 14 may be omitted.

The side ends of the film 20 sent from the clip tenter 14 is cuts off by an edge slitting device 51. The edge slitting device 51 is provided with a crusher 52. After being cut away, the side ends of the film 20 are sent to the crusher 52 to be crushed into pieces. The pieces of film 20 thus crushed are reused as a primary dope.

The film 20 whose side ends are cut off by the edge slitting device 51 is sent to the drying chamber 15. The drying chamber 15 includes plural rollers 53 and an adsorption and recovery device 54. The film 20 is conveyed by the rollers 53 in the drying chamber 15. The film 20 dried in the drying chamber 15 is sent to the cooling chamber 16 to be cooled therein such that the temperature of the film 20 goes down to at least 30° C. Then, the film 20 is sent to the winding chamber 17. Additionally, a compulsory neutralization device (neutralization bar) 55 is disposed in the downstream side from the cooling chamber 16 that is next to the drying chamber 15. Moreover, a knurling roller 56 is disposed in the downstream side from the neutralization device 55 in this embodiment.

The winding chamber 17 contains a winder 57 and a press roller 58. The film 20 sent to the winding chamber 17 is wound around the core 57a rotated by the winder 57 while being pressed against the core 57a by the press roller 58.

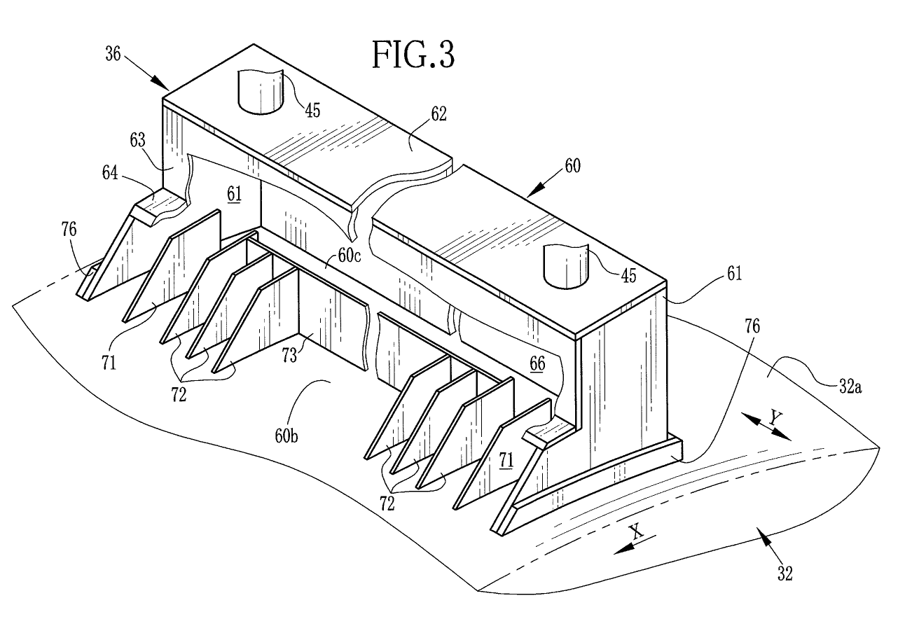

As shown in FIGS. 2 and 3, the decompression chamber 36 is constituted by a casing 60. The casing 60 is formed by a pair of side boards 61 disposed along the X direction, a top board 62 bridged over the pair of side boards 61, a first front board 63, a second front board 64, and a rear board 66 such that the inside of the casing 60 is the cavity 60a. Note that the casing 60 is disposed such that the lower end of each of the side boards 61 and the rear boards 66 is close to the peripheral surface 32a. The casing 60 has an opening 60b partially blocked by a front end 30c of the casting die 30 at its front side in the downstream side in the X direction. At the bottom of the casing 60 is provided an opening 60c so as to be close to the peripheral surface 32a of the casting drum 32. Preferably, a material for the respective boards 61 to 66 is not easily dissolved into the organic solvent, and has strength enough to withstand differential pressure between the inside and the outside of the casing 60. The respective boards 61 to 66 are made of stainless steel, for example.

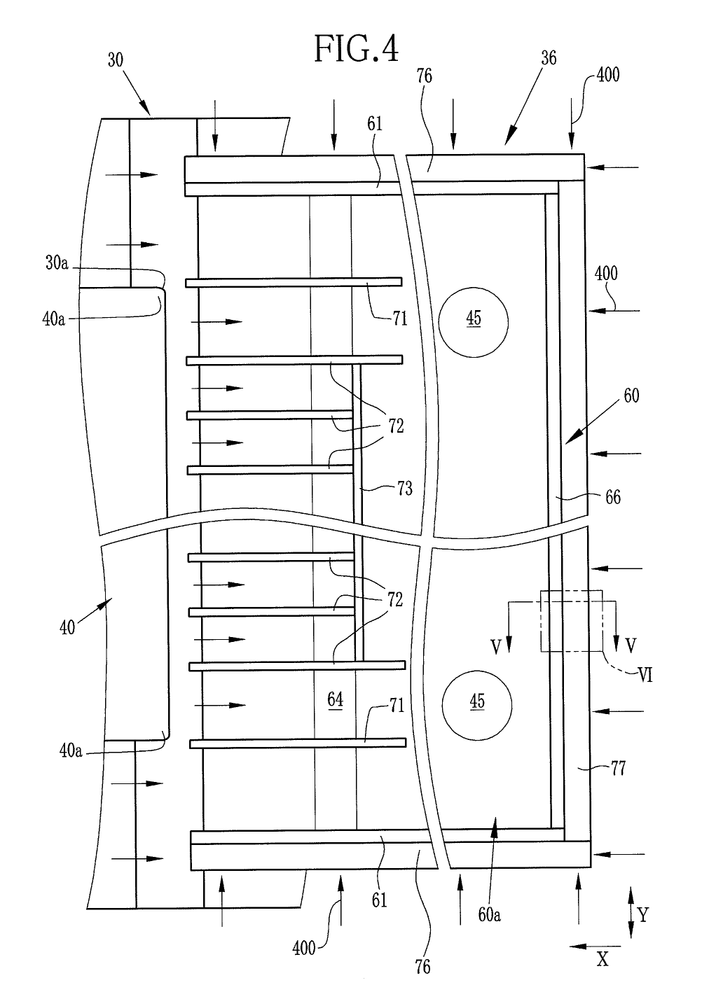

As shown in FIGS. 3 and 4, plural plates 71 and 72 are disposed so as to stand upright along the X direction in the casing 60. The plural plates 71 and 72 divide the cavity 60a of the casing 60 into plural sections in a width direction of the casting film 33 (hereinafter referred to as Y direction). The plates 71 and 72 function as flow regulating plates for air (wind) 400 flowing due to the suction of the decompression chamber 36. Among the plural plates 71 and 72, the plates 71 disposed in the upstream side from each end 40a of the casting bead 40 in the X direction are referred to as outer side seal plates 71, and the plates 72 disposed between the pair of outer side seal plates 71 are referred to as inner side seal plates 72.

A lateral seal plate 73 is disposed along the Y direction in the casing 60. The lateral seal plate 73 is fixed to the ends of the inner side seal plates 72 in the upstream side in the X direction such that the inner side seal plates 72 stand upright. Each of the seal plates 71 to 73 is preferably made of, for example, MC nylon (registered trademark) or Teflon (registered trademark) that is not easily dissolved into the organic solvent.

A pair of side labyrinth plates 76 and a lateral labyrinth plate 77 are disposed outside the casing 60. The pair of side labyrinth plates 76 are disposed along the side boards 61. The lateral labyrinth plate 77 is disposed along the rear board 66. Each of the labyrinth plates 76 and 77 is provided with a labyrinth groove described later. The labyrinth grooves can prevent the flowing air 400 from entering the cavity 60a. Note that in a case where the side labyrinth plates 76 and the lateral labyrinth plate 77 are not used, the labyrinth groove may be directly provided in a bottom surface of each of the side boards 61 and the rear board 66 constituting the casing 60. Note that the lines V-V of FIG. 4 correspond to the direction of flowing air in a case where the labyrinth groove is formed on the lateral labyrinth plate 77. In contrast, the lines V-V of FIG. 4 correspond to a direction perpendicular to the direction of flowing air in a case where the labyrinth groove is formed on the side labyrinth plates 76.

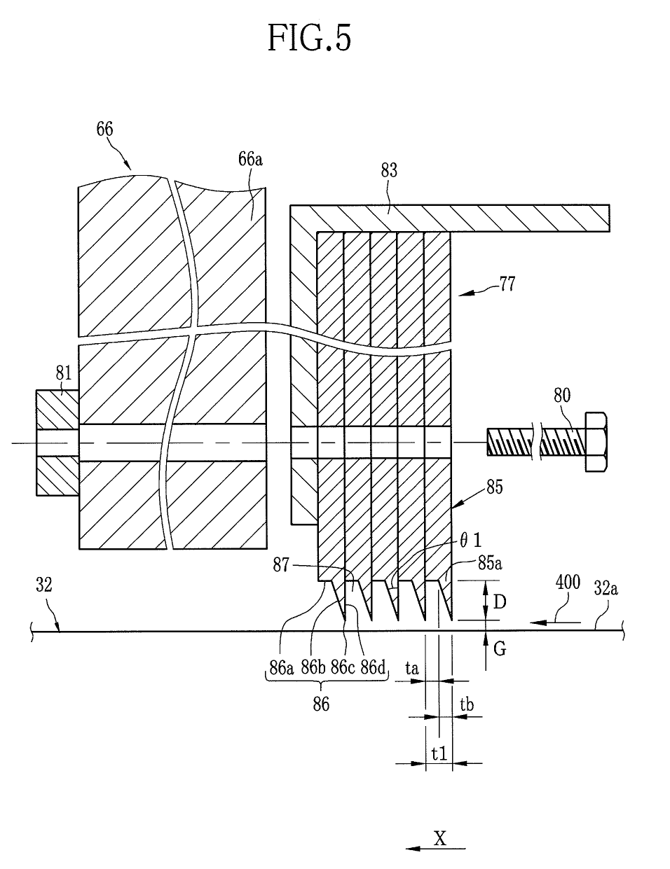

As shown in FIG. 5, the lateral labyrinth plate 77 is fixed to an end portion 66a of the rear board 66 through a mounting bracket 83 with a screw 80 and a nut 81. The lateral labyrinth plate 77 is disposed at a lower end portion of the end portion 66a and extends along the Y direction. The lateral labyrinth plate 77 is composed of five seal members 85 arranged so as to be in close contact with each other in the X direction. The seal member 85 is preferably made of MC nylon (registered trademark) and Teflon (registered trademark) that is not easily dissolved into the organic solvent.

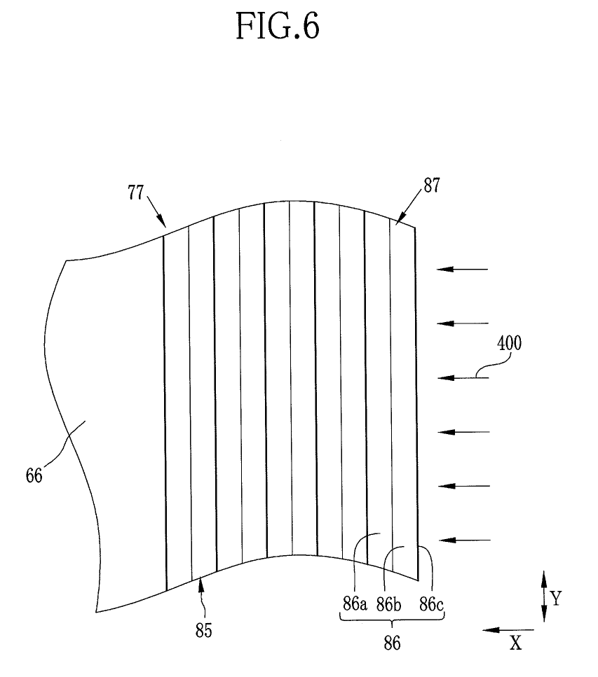

As shown in FIGS. 5 and 6, each of the seal members 85 is disposed along the Y direction and vertical to the peripheral surface 32a. Each of the seal members 85 is disposed such that the end portion thereof protrudes from the lower end of the decompression chamber 36 toward the peripheral surface 32a of the support 32. Each of the protruded portions, in other words, a ledge includes an end portion 85a having a groove forming portion 86 extending along the Y direction. Note that in a case where the labyrinth groove is directly formed on the bottom surface of each of the side boards 61 and the rear board 66 constituting the casing 60, each of the side boards 61 and the rear board 66 may include a ledge similar to the above on its bottom surface.

The groove forming portion 86 is composed of a bottom surface 86a, an inclined surface 86b, an edge portion 86c, and a vertical surface 86d in this order from the downstream side to the upstream side in the X direction. A clearance between the bottom surface 86a and the peripheral surface 32a is approximately constant along the X and Y directions. A clearance between the inclined surface 86b and the peripheral surface 32a is gradually decreased from the downstream side to the upstream side in the X direction. The edge portion 86c is defined by the inclined surface 86b and the vertical surface 86d in the upstream side from the inclined surface 86b in the X direction. Each of the edge portions 86c has a cross section with an acute tip angle θ1 in a direction of the flowing air. The tip angle θ1 is preferably in the range of 20° to 60°, and more preferably in the range of 30° to 50°. An area of the cross section of the groove forming portion 86, which is perpendicular to the Y direction, is preferably in the range of 300 to 2000 mm², and more preferably in the range of 700 to 1500 mm². Note that the groove forming portion 86 may be disposed such that the vertical surface 86d and the peripheral surface 32a intersect with each other at an acute angle and the inclined surface 86b and the peripheral surface 32a intersect with each other at a right angle.

The seal members 85 each having the groove forming portion 86 at its end portion 85a are arranged so as to be in close contact with each other in the X direction, and thereby labyrinth grooves 87 are formed along the Y direction at the lower end portion of the lateral labyrinth plate 77.

Next, an operation of the film production line 10 having the above-described structure is described. As shown in FIGS. 1 and 2, the casting drum 32 rotates around the shaft such that the peripheral surface 32a thereof moves in the X direction. The dope 21 is cast through the discharge port 30a onto the peripheral surface 32a to form the casting bead 40 extending from the discharge port 30a to the peripheral surface 32a. The suction device 46 sucks air of the cavity 60a of the decompression chamber 36. Due to the suction, the air in the upstream side from the casting bead 40 flows toward the cavity 60a.

Upon movement of the peripheral surface 32a, the flowing air 400 is generated along the peripheral surface 32a so as to flow toward the casting bead 40. Due to the suction by the suction device 46, the flowing air 400 is flown into the opening 60c through the clearance between the lateral labyrinth plate 77 and the peripheral surface 32a.

As shown in FIG. 5, according to the present invention, the labyrinth grooves 87 are formed at the end portion of the lateral labyrinth plate 77 in the periphery of the peripheral surface 32a. The labyrinth grooves 87 are constituted by the seal members 85 each having the edge portion 86c. Each of the edge portions 86c has a cross section with an acute angle in a direction of the flowing air. Therefore, the flowing air 400 frown into the clearance between the lateral labyrinth plate 77 and the peripheral surface 32a is compressed at the time of passing through the clearance between the edge portion 86c and the peripheral surface 32a, and further swollen in the labyrinth groove 87 constituted by the bottom surface 86a and the inclined surface 86b. Since the flowing air 400 is compressed and swollen as described above, it is possible to prevent the flowing air 400 from entering through the opening 60c. Further, according to the present invention, since it is possible to increase airtightness of the decompression chamber 36, even when the clearance between the decompression chamber 36 and the peripheral surface 32a changes, it is possible to prevent pressure fluctuation inside the decompression chamber 36 caused by the change in the clearance. Therefore, according to the present invention, it is possible to prevent pressure fluctuation of the cavity 60a caused by the flowing air 400 entering through the opening 60c during the casting process. Therefore, it is possible to produce the film while preventing occurrence of thickness unevenness and the defect on the surface of the film.

The edge portion 86c may have any shape as long as it can compress the air passing through the clearance between the edge portion 86c and the peripheral surface 32a. Each of the inclined surface 86b, the bottom surface 86a, and the vertical surface 86d of the labyrinth groove 87 may have any shape as long as the flowing air 400 passing through the clearance between the edge portion 86c and the peripheral surface 32a can be swollen in the labyrinth groove 87, and preferably the inclined surface 86b has a shape allowing the air just after having passed through the clearance between the edge portion 86c and the peripheral surface 32a to be swollen. A depth D of the labyrinth groove 87, which is obtained by subtracting a seal clearance G from a clearance between the bottom surface 86a and the peripheral surface 32a, is preferably gradually increased toward the opening 60c.

The lateral labyrinth plate 77 is preferably attached to the decompression chamber 36 such that the seal clearance G between the edge portion 86c and the peripheral surface 32a is within the range of 0.1 to 5 mm. Further the seal clearance G is preferably within the range of 0.3 to 2 mm. In a case where the lateral labyrinth plate 77 has plural edge portions 86c, the smallest clearance between the edge portion 86c and the peripheral surface 32a may be considered as the seal clearance G. A thickness t1 of the seal member 85 is preferably within the range of 1 to 20 mm. Further, it is preferable that a width ta of the bottom surface 86a in the X direction is within the range of 1 to 20 mm, a width tb of the inclined surface 86b in the X direction is within the range of 0.1 to 1 mm, and the depth D of the labyrinth groove 87 is within the range of 1 to 10 mm.

Although the end portion 85a has the bottom surface 86a, the inclined surface 86b, the edge portion 86c, and the vertical surface 86d in this order from the downstream side to the upstream side in the X direction in the above embodiment, the present invention is not limited thereto. The order may be from the upstream side to the downstream side in the X direction.

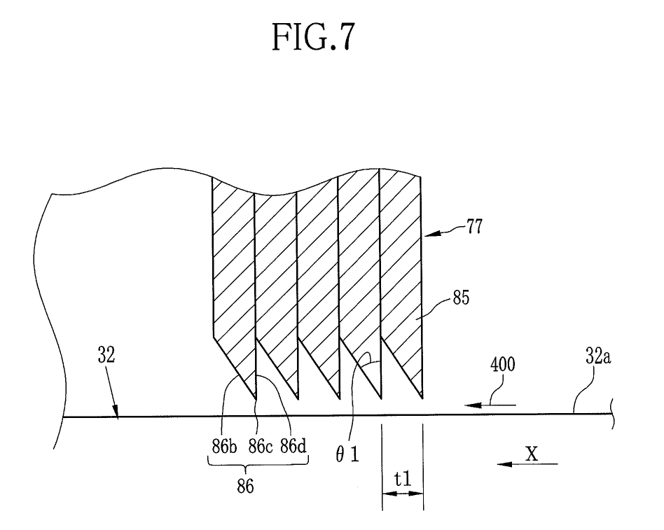

Although the end portion 85a of the seal member 85 is provided with the groove forming portion 86 including the bottom surface 86a, the inclined surface 86b, the edge portion 86c, and the vertical surface 86d in the above embodiment, the present invention is not limited thereto. Alternatively, as shown in FIG. 7, the end portion 85a of the seal member 85 may be provided with the groove forming portion 86 including the inclined surface 86b, the edge portion 86c, and the vertical surface 86d. Note that, as long as the edge portion 86c has a cross section with an acute angle, the cross section of the labyrinth groove 87 may be any shape such as a V-shaped groove, a U-shaped groove, and a square groove.

Although the lateral labyrinth plate 77 is composed of the five seal members 85 arranged so as to be in close contact with each other in the X direction in the above embodiment, the present invention is not limited thereto. The lateral labyrinth plate 77 may be composed of at least two seal members 85 arranged so as to be in close contact with each other in the X direction and thereby has the labyrinth grooves 87. Note that it is also possible to form the labyrinth grooves 87 at the end portion of the lateral labyrinth plate 77 by machining or the like, instead of arranging the seal members 85 in a close contact manner so as to form the labyrinth grooves 87. In this case, the end portion of the lateral labyrinth plate 77 facing toward the support 32, namely the lower end portion of the lateral labyrinth plate 77, may include a ledge as described above.

Although the labyrinth groove 87 is formed at the end portion of the side labyrinth plate 76 and the lateral labyrinth plate 77 in the above embodiment, the present invention is not limited thereto. The labyrinth groove 87 may be formed at least one of the side labyrinth plate 76 and the lateral labyrinth plate 77.

The labyrinth groove 87 is preferably formed at the end portion of each of the outer side seal plate 71, the inner side seal plate 72, and the lateral seal plate 73, in addition to the side labyrinth plate 76 and the lateral labyrinth plate 77. Thereby, it becomes possible to increase flow regulating effect in the periphery of side edges of the casting bead 40 and prevent vibration of the casting bead 40.

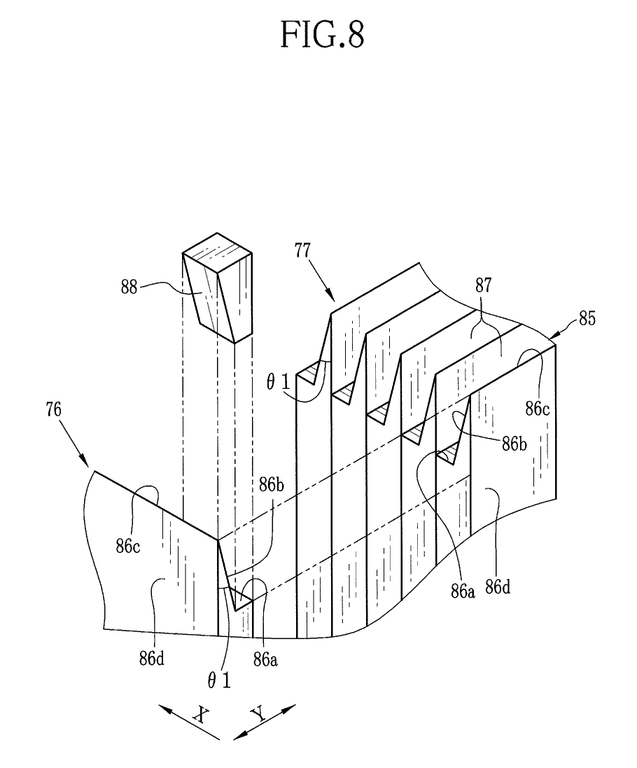

As shown in FIG. 8, in a case where each of the labyrinth grooves 87 is provided in an entire area in the Y direction of the lateral labyrinth plate 77, a shielding member may be provided at the ends of the lateral labyrinth plate 77 in the Y direction so as to shield the cross sections of each of the labyrinth grooves 87. Although the shielding member is not especially limited as long as it can shield the cross sections of each of the labyrinth grooves 87, the side labyrinth plate 76 or the like may be used as the shielding member. As shown in FIG. 8, for example, the side labyrinth plate 76 may be disposed so as to shield the ends in the Y direction of the lateral labyrinth plate 77. Alternatively, in a case where each of the labyrinth grooves 87 is provided in an entire area in the X direction of each of the side labyrinth plates 76, for example, a shielding member 88 may be disposed at the end in the X direction of the labyrinth groove 87. Note that the shielding member 88 may be integrated with the seal member 85.

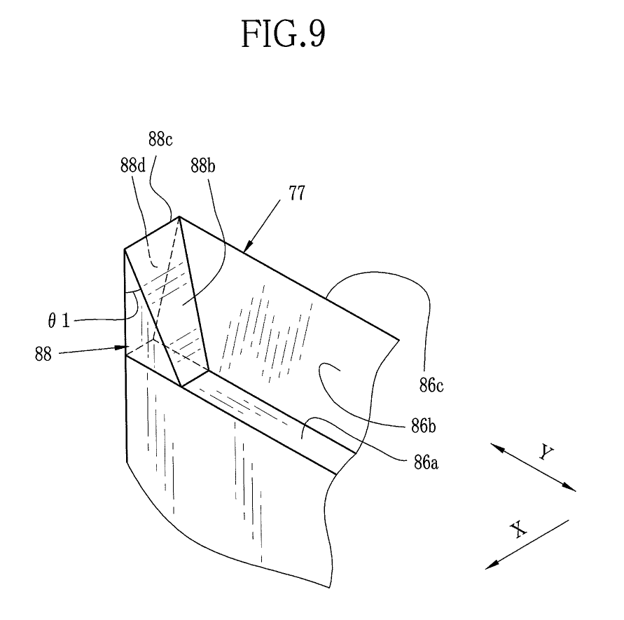

Further, as shown in FIG. 9, the shielding member 88 may be provided with an inclined surface 88b, an edge portion 88c, and a vertical surface 88d in this order from the cavity 60a toward the outside of the decompression chamber 36. The inclined surface 88b has the same shape as that of the inclined surface 86b. The vertical surface 88d has the same shape as that of the vertical surface 86d. As in the case of the edge portion 86c, the edge portion 88c preferably has a cross section with an acute angle in a direction of the flowing air. Alternatively, the shielding members 88 may be aligned in the Y direction.

As the width of the film 22 to be produced is increased, the width of the casting film is also increased. As a result, there easily occurs pressure fluctuation of the cavity 60a of the decompression chamber 36. According to the casting device of the present invention, even if the width of the casting film is increased, it is possible to prevent the pressure fluctuation of the cavity 60a of the decompression chamber 36. The width of the casting film is preferably at least 600 mm, and more preferably in the range of 1400 to 2500 mm, for example. Additionally, in a case where the width of the casting film is more than 2500 mm, the present invention is effective.

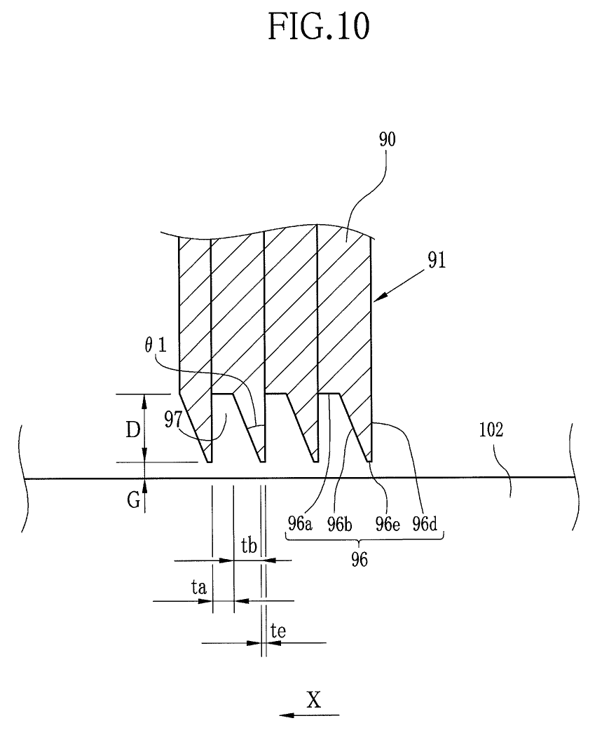

According to the present invention, as long as the tip angle θ1 made between the inclined surface 86b and the vertical surface 86d is acute, the tip angle θ1 of the edge portion 86c is acute. Accordingly, the present invention is not limited to the above embodiments, and a lateral labyrinth plate 91 shown in FIG. 10 is also applicable in the present invention. The labyrinth plate 91 is composed of seal members 90 arranged so as to be in close contact with each other in the X direction. A groove forming portion 96 is formed at an end portion of each of the seal members 90 in the periphery of the peripheral surface 32a. The groove forming portion 96 is composed of a bottom surface 96a, an inclined surface 96b, an edge surface 96e, and a vertical surface 96d in this order from the cavity 60a toward the outside of the decompression chamber 36. The bottom surface 96a has the same shape as that of the bottom surface 86a. The inclined surface 96b has the same shape as that of the inclined surface 86b. The vertical surface 96d has the same shape as that of the vertical surface 86d. As long as the tip angle θ1 made between the inclined surface 96b and the vertical surface 96d is acute, an embodiment in which the edge surface 96e is provided instead of the edge portion 86c is naturally also applicable. The width te of the edge surface 96e in the X direction is preferably 1.5 mm, and more preferably at most 1.0 mm. The seal members 90 each having the groove forming portion 96 at its end portion are arranged so as to be in close contact with each other in the X direction, and thereby labyrinth grooves 97 are formed along the Y direction at the end portion of the lateral labyrinth plate 91 in the periphery of the peripheral surface 32a.

Further, for the purpose of casting the dope, co-casting by simultaneous stacking and co-casting by sequential stacking can be selectively used. In the co-casting by simultaneous stacking, two or more kinds of dopes are subjected to co-casting simultaneously to be stacked. In the co-casting by sequential stacking, plural kinds of dopes are subjected to co-casting sequentially to be stacked. Note that the co-casting by simultaneous stacking and the co-casting by sequential stacking may be combined to be used. In the co-casting by simultaneous stacking, a casting die provided with a feed block may be used, or a multi-manifold-type casting die may be used. Note that, in a multilayer film obtained by the co-casting, at least any one of thickness of the layer at the side exposed to air and the thickness of the layer at the side of the support is preferably 0.5 to 30% relative to the total thickness of the film. Further, in the co-casting by simultaneous stacking, when the dope is cast onto the support through a die slit (discharge port), the dope with high viscosity is preferably surrounded by the dope with low viscosity. In the casting bead formed so as to extend from the die slit to the support, the dope exposed outside preferably has a relative proportion of alcohol higher than that of the dope located inside.

Moreover, the present invention is also applicable to a casting device using a casting belt instead of the casting drum 32. The casting belt is bridged over rotation rollers and moves.

### EXAMPLE 1

(Experiment 1)

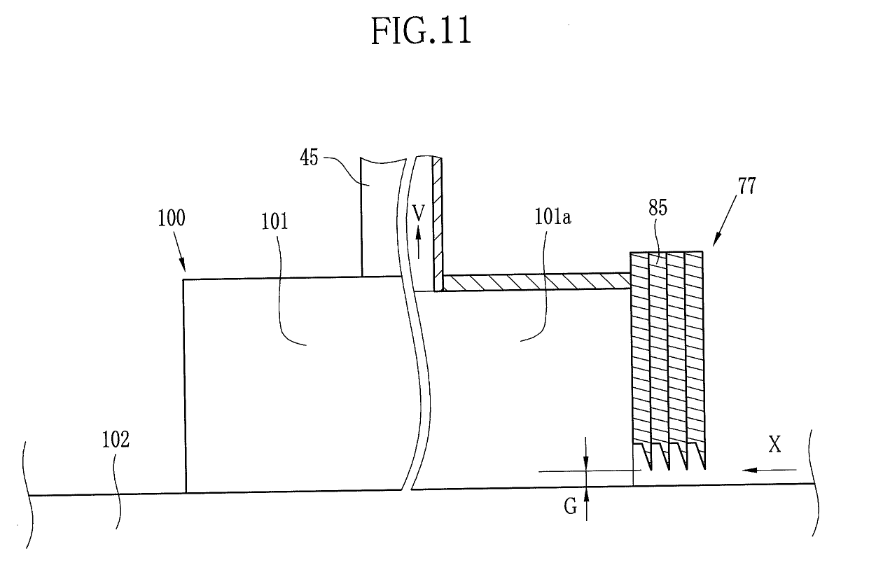

In Experiment 1, a decompression chamber 100 shown in FIG. 11 was used. The decompression chamber 100 is composed of a casing 101 and the lateral labyrinth plate 77. The casing 101 is a box and disposed above the support 102. The casing 101 is composed of a top board, a pair of side boards, and a front board. Each of the bottom and rear of the casing 101 has an opening, and a cavity 101a is exposed outside through each of the openings. The lateral labyrinth plate 77 is disposed on the rear side of the casing 101, which has the opening, so as to close the opening. The pair of side boards and the front board are disposed so as to face the support 102. Accordingly, the cavity 101a is in an approximately hermetically-sealed. The lateral labyrinth plate 77 is composed of four seal members 85 arranged so as to be in close contact with each other in the X direction. Thereby, three labyrinth grooves 87 shown in FIG. 5 are formed. Note that for the purpose of preventing complexity of the drawing, the labyrinth groove 87 is not shown in detail in FIG. 11 (Refer to FIG. 5). The width ta of the bottom surface 86a of the labyrinth groove 87 was 3 mm, the width tb of the inclined surface 86b was 5 mm, and the depth D of the labyrinth groove 87 was 8.65 mm. As shown in FIG. 11, a position of the lateral labyrinth plate 77 was adjusted such that the seal clearance G was in the range of 0.3 to 2 mm. The pipe 45 connects the casing 101 and the suction device 46 (see FIG. 1). A not-shown air flow velocity meter (Climomaster made by KANOMAX JAPAN, INC.) and a not-shown probe (MODEL 6552) are disposed in the pipe 45. The air flow velocity meter and the probe are used to detect air flow velocity V sucked by the duct of the pipe 45 (hereinafter referred to as duct sucking air flow velocity V). The suction device 46 sucks air of the cavity 101a such that the cavity 101a is decompressed to have a predetermined decompression degree P. The duct sucking air flow velocity V measured at the predetermined decompression degree P was checked.

(Experiment 2)

The duct sucking air flow velocity V measured at the predetermined decompression degree P was checked under the same conditions as those in Experiment 1 except that the lateral labyrinth plate 91 composed of the seal members 90 shown in FIG. 10 was disposed instead of the lateral labyrinth plate 77 and the width te of the edge surface 96e was 1 mm.

(Experiment 3)

The duct sucking air flow velocity V measured at the predetermined decompression degree P was checked under the same conditions as those in Experiment 1 except that the lateral labyrinth plate was composed of the five seal members 85 arranged so as to be in close contact with each other.

(Experiment 4)

The duct sucking air flow velocity V measured at the predetermined decompression degree P was checked under the same conditions as those in Experiment 1 except that a seal member having thickness of 5 mm and no groove forming portion 86 at its end portion was used instead of the lateral labyrinth plate 77.

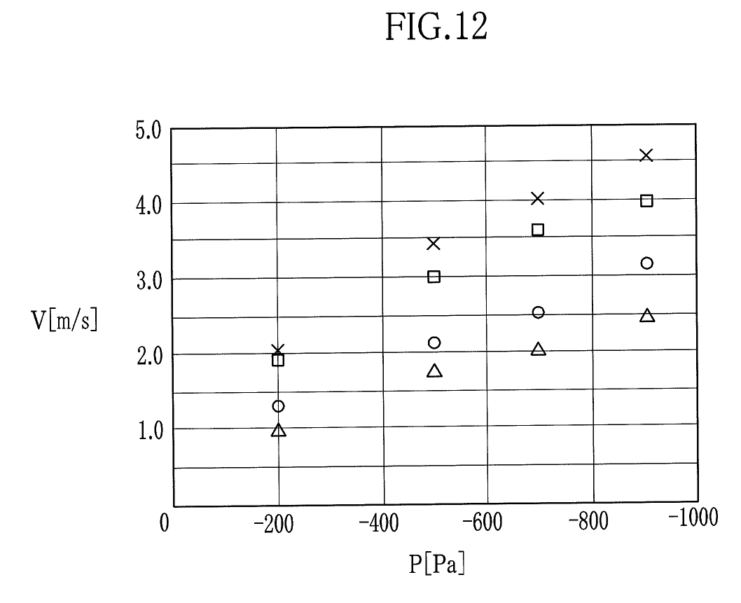

The duct sucking air flow velocity V (unit;m/s) measured at the predetermined decompression degree P in each of the Experiments 1 to 4 is shown in FIG. 12. The data in Experiment 1 is denoted by “o”, the data in Experiment 2 is denoted by “□”, the data in Experiment 3 is denoted by “Δ”, and the data in Experiment 4 is denoted by “x”.

### Embodiment 2

(Experiment 1)

The duct sucking air flow velocity V measured at the predetermined decompression degree P was checked under the same conditions as those in Experiment 1 of Example 1 except that the position of the lateral labyrinth plate 77 was adjusted such that the seal clearance G was half of that in Experiment 1 of Example 1.

(Experiment 2)

The duct sucking air flow velocity V measured at the predetermined decompression degree P was checked under the same conditions as those in Experiment 2 of Example 1 except that the position of the lateral labyrinth plate 91 was adjusted such that the seal clearance G was half of that in Experiment 2 of Example 1.

(Experiment 3)

The duct sucking air flow velocity V measured at the predetermined decompression degree P was checked under the same conditions as those in Experiment 2 of Example 1 except that the position of the seal member was adjusted such that the seal clearance G was half of that in Experiment 4 of Example 1.

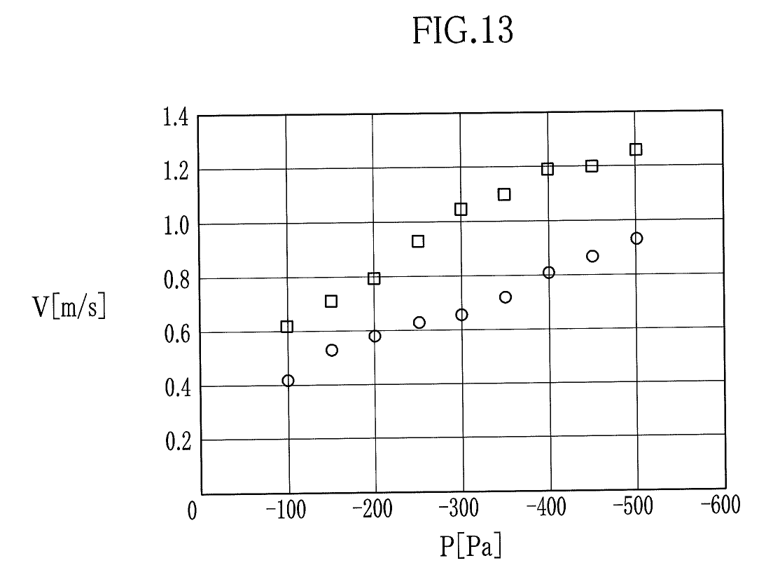

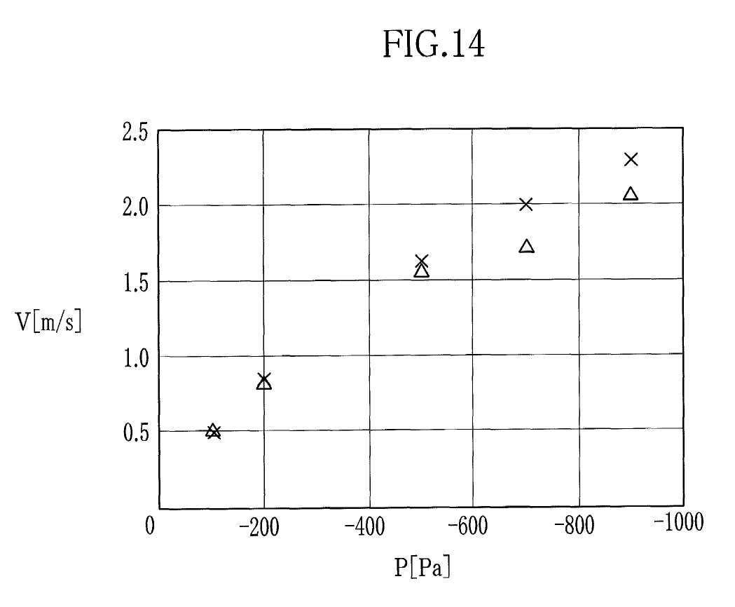

The duct sucking air flow velocity V measured at the predetermined decompression degree P in each of the Experiments 1 and 2 is shown in FIG. 13. The data in Experiment 1 is denoted by “o”, and the data in Experiment 2 is denoted by “□”. Further, the duct sucking air flow velocity V measured at the predetermined decompression degree P in each of Experiment 3 of Example 2 and Experiment 3 of Example 1 is shown in FIG. 14. The data in Experiment 3 of Example 2 is denoted by “×”, and the data in Experiment 3 of Example 1 is denoted by “Δ”.

By referring to FIGS. 12 and 13, it is possible to prevent air from flowing into the cavity 60a from outside of the decompression chamber 36 in the present invention. Therefore, according to the present invention, it is possible to prevent pressure fluctuation of the cavity 60a caused by the air flowing into the cavity 60a. Further, it becomes possible to prevent occurrence of thickness unevenness. Additionally, by referring to FIG. 14, even when the seal clearance G is increased, the seal member of the present invention makes it possible to achieve the duct sucking air flow velocity V which is the same as that obtained by using a conventional seal member. When the seal clearance G is changed, the duct sucking air flow velocity V is also changed in accordance with the change in the seal clearance. Namely, the change amount of the duct sucking air flow velocity V is increased as the seal clearance G is decreased. Further, when the seal clearance G is decreased, scratches may be generated on the surface of the support in some cases, and thereby resulting in unfavorable result. Accordingly, according to the present invention, it is possible to prevent the increase in the duct sucking air flow velocity V without causing scratches on the surface of the support and without adjusting the seal clearance G with high precision.

Various changes and modifications are possible in the present invention and may be understood to be within the present invention.

What is claimed is:

1. A casting device comprising:
a support moving continuously;
a casting die for discharging a casting dope onto said support to form a casting film;
a decompression chamber for sucking air of an upstream area from a casting bead in a moving direction of said support to decompress the upstream area, said casting bead being said casting dope extending from said casting die to said support; and
two ledges provided on said decompression chamber to form a labyrinth groove between said decompression chamber and said support, said labyrinth groove extending in a direction perpendicular to air flowing between said decompression chamber and said support, each of said ledges including an edge portion, said edge portion having a cross section with an acute angle in a direction of said flowing air, said flowing air occurring with the sucking, said labyrinth groove being formed between said edge portions.

2. A casting device as defined in claim 1, wherein said edge portion is formed by a perpendicular surface perpendicular to the moving direction of said support and an inclined surface intersecting with said perpendicular surface, said perpendicular surface and said inclined surface making an acute angle.

3. A casting device as defined in claim 2, wherein said labyrinth groove is formed by said perpendicular surface and said inclined surface provided alternately in this order from an upstream side in the direction of said flowing air occurring with the suction.

4. A casting device as defined in claim 3 further comprising a shielding member disposed at both end portions in a longitudinal direction of said labyrinth groove, said shielding member being used for closing said labyrinth groove to shield said flowing air occurring with the suction.

5. A casting device as defined in claim 4, wherein said support is a drum rotated around a center of its cross section, said casting film being formed on a peripheral surface of said support.

6. A solution casting device comprising:
a support moving continuously;
a casting die for discharging a casting dope onto said support to form a casting film;
a decompression chamber for sucking air of an upstream area from a casting bead in a moving direction of said support to decompress the upstream area, said casting bead being said casting dope extending from said casting die to said support;
two ledges provided on said decompression chamber to form a labyrinth groove between said decompression chamber and said support, said labyrinth groove extending in a direction perpendicular to air flowing between said decompression chamber and said support, each of said ledges including an edge portion, said edge portion having a cross section with an acute angle in a direction of said flowing air, said flowing air occurring with the sucking, said labyrinth groove being formed between said edge portions; and
a drier for drying said casting film peeled from said support to form a film.

7. A solution casting method comprising the steps of:
discharging a casting dope from a casting die onto a support moving continuously to form a casting film;
sucking an upstream area from a casting bead in a moving direction of said support to decompress said upstream area by a decompression chamber, said casting bead being said casting dope extending from said casting die to said support;
compressing air flowing between said decompression chamber and said support by one of two ledges for forming a labyrinth groove, said labyrinth groove extending in a direction perpendicular to said flowing air, said air occurring with the sucking;
swelling said compressed air by said labyrinth groove formed between edge portions, each of said edge portions being provided at said ledges;
peeling said casting film from said support; and
drying said peeled casting film to form a film.
